(19) United States
(12) Patent Application Publication
(10) Pub. No.: US 2025/0020205 A1
(43) Pub. Date: Jan. 16, 2025

(54) SHUTTLE SHIFT BASED DIRECTION CHANGES FOR A WORK MACHINE

(71) Applicant: Caterpillar Paving Products Inc., Brooklyn Park, MN (US)

(72) Inventors: Jeremy Wayne LEE, Otsego, MN (US); Kyle J. CANTWELL, Roseville, MN (US); Ryan Adam ENOT, Elburn, IL (US); Matthew Daryl CHISHOLM, Maple Grove, MN (US); Tim J. LINDHOLM, Ham Lake, MN (US); Garrett D. REED, Big Lake, MN (US)

(73) Assignee: Caterpillar Paving Products Inc., Brooklyn Park, MN (US)

(21) Appl. No.: 18/350,229

(22) Filed: Jul. 11, 2023

(51) Int. Cl. F16H 59/10; F16H 59/12

(52) U.S. Cl. CPC F16H 59/105; F16H 59/12; F16H 2059/0256

(57) ABSTRACT

In some implementations, a controller of a work machine may obtain a first operator input associated with a shuttle shift input component of the work machine. The controller may obtain a second operator input associated with changing a position of a rotatable operator seat of the work machine. The controller may cause, in response to obtaining both the first operator input and the second operator input, a direction of movement of the work machine to change from a first direction to a second direction.

### TECHNICAL FIELD

The present disclosure relates generally to work machines and, for example, to shuttle shift based direction changes for a work machine.

### BACKGROUND

Some work machines may be associated with cyclic operations, such as frequently changing between a forward and reverse direction of travel. For example, a compactor machine may frequently switch between the forward and reverse direction of travel when compacting a surface material. Compaction of a surface material, such as soil or asphalt, can improve strength and stability of the surface. In a paving context, a paving machine distributes hot paving material, such as asphalt, over a surface, and a mobile compactor machine follows the paving machine to compact the material to a desired density and obtain an acceptable surface finish. Commonly, the compactor machine may include one or more compaction drums that serve to propel the compactor machine and compact the paving material via the weight of the compactor machine.

However, changing the direction of travel of the compactor machine may result in the compactor machine slowing down and/or stopping while on hot paving material (e.g., to place the engine of the compactor machine into neutral to change the direction of travel). As a result of the compactor machine slowing down and/or stopping while on hot paving material, a surface of the paving material may be deformed or damaged, thereby requiring reworking or repair of the surface that consumes machine hours, increases machine wear, and/or increases fuel consumption. Further, an operator may use a lever (e.g., a joystick) to control the direction of travel of the compactor machine. The frequent changes between the forward and reverse directions may cause operator fatigue associated with interacting with the lever. In some cases, the compactor machine may have an operator seat that is configured to rotate so that the operator can adjust their position, depending on the direction the compactor machine is moving. The frequent changes between the forward and reverse directions in combination with the rotatable operator seat may be disorienting for the operator, thereby introducing safety risks caused by the operator being incorrect as to the direction of travel that will result from an input to the lever by the operator.

U.S. Pat. No. 9,777,461 (the '461 patent) discloses an operator control for a work vehicle. The operator control may include an array of controls. At the upper part of the control area are gear down and gear up controls, below that is a transmission control, and below that is a circle rotate control. The transmission control may be a three-position rocker switch, including a central “neutral” transmission position between “forward” and “reverse” transmission positions. While the transmission control may enable the transmission of the work vehicle to change between forward and reverse directions, the '461 patent does not address that the work vehicle may still need to come to a stop (e.g., be placed in neutral) to switch directions. Additionally, the '461 patent does not address how to deal with the disorientation that may occur for an operator with frequent changes between the forward and reverse directions and with changes in operator seat positions.

The work machine and/or controller of the present disclosure solves one or more of the problems set forth above and/or other problems in the art.

### SUMMARY

A work machine may include a power source configured to move the work machine in a forward direction and a reverse direction; an operator seat rotatably attached to the work machine; a lever that is movable along a first axis to cause the work machine to move in the forward direction or the reverse direction; and a shuttle shift input component, wherein a change in a direction of movement of the work machine, of the forward direction and the reverse direction, is responsive to a first input to the shuttle shift input component and a second input indicating that a rotational position of the operator seat is changing.

A method may include obtaining, by a controller of a work machine, a first operator input associated with a shuttle shift input component of the work machine; obtaining, by the controller, a second operator input associated with changing a position of a rotatable operator seat of the work machine; and causing, by the controller and in response to obtaining both the first operator input and the second operator input, a direction of movement of the work machine to change from a first direction to a second direction.

A controller of a work machine may include one or more memories; and one or more processors, coupled to the one or more memories, configured to: obtain a first operator input associated with a shuttle shift input component of the work machine; obtain a second operator input associated with initiating a rotation of a rotatable operator seat of the work machine; and cause, based on the first operator input and the second operator input, a direction of movement of the work machine to change from a first direction to a second direction.

### BRIEF DESCRIPTION OF THE DRAWINGS

FIG. 1 is a side view of an example machine described herein.

FIG. 2 is a top view of examples of an operator station of the machine described herein.

FIG. 3 is a perspective view of an example drive system control of the machine described herein.

FIG. 4 is an example associated with shuttle shift based direction changes for a work machine described herein.

FIG. 5 is a flowchart of an example process associated with shuttle shift based direction changes for a work machine.

FIG. 6 is a diagram of example components of a device associated with shuttle shift based direction changes for a work machine.

### DETAILED DESCRIPTION

This disclosure relates to a controller for controlling directional changes, which is applicable to any machine that cyclically and/or frequently changes direction. For example, the machine may be a compactor machine, a vehicle, a paving machine, a cold planer, a grading machine, a backhoe loader, a wheel loader, a harvester, an excavator, a motor grader, a skid steer loader, a tractor, and/or a dozer, among other examples. In some implementations, the machine may be any machine that is capable of changing direction and includes a rotatable operator seat, as described in more detail herein.

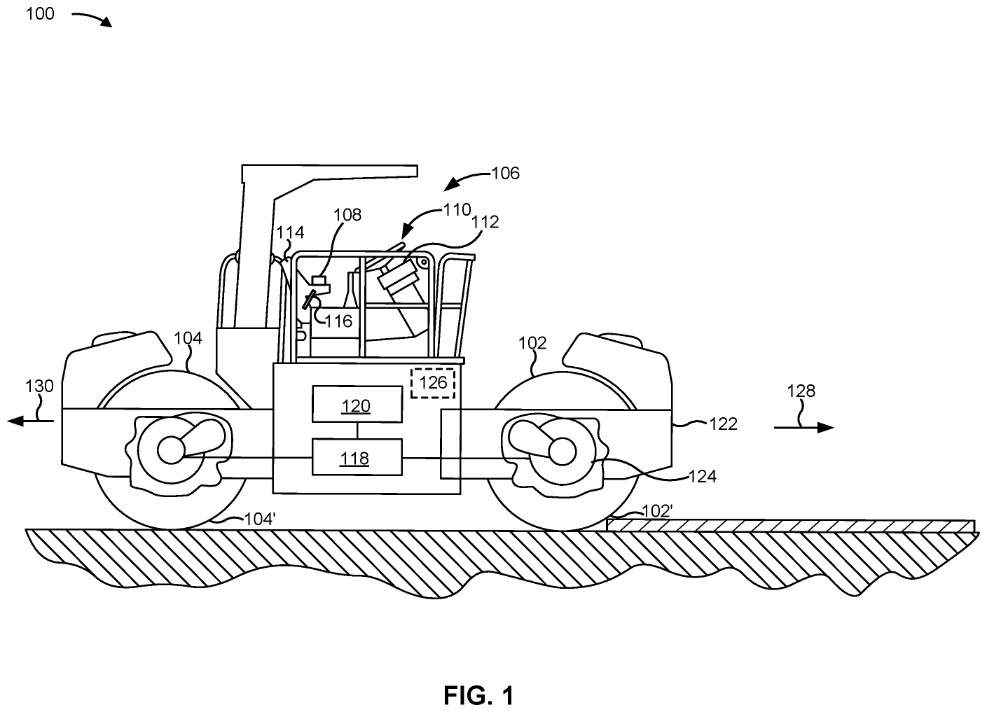

FIG. 1 is a side view of an example machine 100 described herein. While in FIG. 1 the machine 100 is depicted as a compactor machine, the machine 100 may be another type of machine configured to perform compaction of a ground material. The machine 100 may be an asphalt compactor machine (e.g., a self-propelled, double-drum compactor machine), and/or a vibratory drum compactor machine, among other examples. For example, the machine 100 may be used to compact various materials, such as soil and/or asphalt, among other examples. The machine 100 may also be referred to herein as a work machine.

The machine 100 has at least one compaction member, such as a compaction drum. For example, as shown, the machine 100 has a front compaction drum 102 and a back compaction drum 104. The compaction drums 102, 104 are a set of ground-engaging members that provide ground engagement of the machine 100 at surfaces 102′, 104′ of the compaction drums 102, 104, respectively. The surfaces 102′, 104′ may include cylindrical surfaces that form exteriors of shells of the compaction drums 102, 104, respectively. As the machine 100 passes over a mat of paving material, the surfaces 102′, 104′ roll against the paving material and provide compaction forces to the paving material due to a weight of the machine 100. One or more of the compaction drums 102, 104 may include a vibratory component configured to cause the compaction drums 102, 104 to vibrate, thereby further facilitating compaction. In some examples, the machine 100 may include one or more other ground-engaging members, such as one or more wheels and/or one or more tracks, in addition or alternatively to the front compaction drum 102 or the back compaction drum 104.

The machine 100 includes an operator station 106 equipped with various systems and/or mechanisms for control of the operation of the machine 100. For example, the operator station 106 may include a drive system control 108 (such as a shift lever and/or a joystick) and/or a steering system control 110 (shown as a steering wheel). The drive system control 108 may include a lever (e.g., a joystick). For example, a position of such a lever controls a direction of travel and/or a speed of the machine 100. A steering system of the machine 100 may include the steering system control 110, a steering column (e.g., connected to the steering system control 110), a steering actuator (e.g., a steering cylinder for power steering), and/or a steering linkage assembly (e.g., that connects the steering system control 110 or the steering column to ground engagement members, such as the compaction drums 102, 104, via a plurality of linkage members, such as rods). The operator station 106 may also include a display 112 that provides a graphical user interface for operating the machine 100.

The steering system control 110 may include one or more levers (e.g., one or more joysticks) mounted on an operator seat 114. The one or more levers may be included in the drive system control 108 and/or the steering system control 110. For example, the steering system may include one or more pivotable levers (e.g., single-axis levers or multi-axis levers) that can be used by an operator to control a direction of travel and/or speed of the machine 100. In such examples, the machine 100 may not include a steering wheel as shown in FIG. 1. The operator seat 114 may include a rotation component 116. The rotation component 116 may allow for the operator seat to rotate. For example, the rotation component 116 may be a lever that, when interacted with, releases the operator seat 114 to enable the operator seat 114 to rotate. When released, the rotation component 116 may cause the operator seat 114 to lock into a position (e.g., a current position or one of one or more defined positions). For example, the operator seat 114 can be locked or otherwise secured from unintended rotation. Such locking system can be operated, for example, using one or more inputs on the drive system control 108 and/or by interacting with the rotation component 116. The operator can lock the seat position once they are in the desired position by selecting an input (e.g., pushing a button or switch) on the drive system control 108 and/or by disengaging or engaging the rotation component 116.

The machine 100 includes a power source 118 and/or a generator 120 coupled with the power source 118. The power source 118 and the generator 120 are attached to a frame 122 of the machine 100. The generator 120 may serve as an electrical power source for various onboard systems and components of the machine 100. The power source 118 may include an engine (e.g., an internal combustion engine, a gasoline engine, a diesel engine, and/or a gaseous fuel engine), a motor (e.g., an electric motor), and/or a fuel cell, among other examples. A device for storing electrical power that can be supplied to a motor, as well as various onboard systems and components of the machine 100, such as a battery (not shown), may be provided. The power source 118 is configured to drive movement of the machine 100 (e.g., via compaction drums 102, 104) and other components of the machine 100, such as the generator 120. The machine 100 also includes a braking system 124 configured to receive operator input to decrease or arrest a speed of the machine 100.

The machine 100 includes a controller 126 (e.g., an electronic control module (ECM)). The controller 126 may include one or more memories and one or more processors communicatively coupled to the one or more memories. Communicative coupling between a processor and a memory may enable the processor to read and/or process information stored in the memory and/or to store information in the memory. A processor may include a central processing unit, a graphics processing unit, a microprocessor, a controller, a microcontroller, a digital signal processor, a field-programmable gate array, an application-specific integrated circuit, and/or another type of processing component. The processor may be implemented in hardware, firmware, or a combination of hardware and software. The processor may be capable of being programmed to perform one or more operations or processes described elsewhere herein. A memory may include volatile and/or nonvolatile memory. For example, the memory may include random access memory (RAM), read only memory (ROM), a hard disk drive, and/or another type of memory (e.g., a flash memory, a magnetic memory, and/or an optical memory). The memory may be a non-transitory computer-readable medium. The memory may store information, one or more instructions, and/or software (e.g., one or more software applications) related to the operation of the controller 126.

The machine 100 is capable of moving in a forward direction 128 and a reverse direction 130. During a working mode of operation, the machine 100 can be restricted to only moving in the forward direction 128 or the reverse direction 130. The reverse direction 130 is 180 degrees relative to the forward direction 128. The forward direction 128 may be associated with a front of the machine 100 and the reverse direction 130 may be associated with a back (or rear) of the machine 100.

As indicated above, FIG. 1 is provided as an example. Other examples may differ from what is described in connection with FIG. 1.

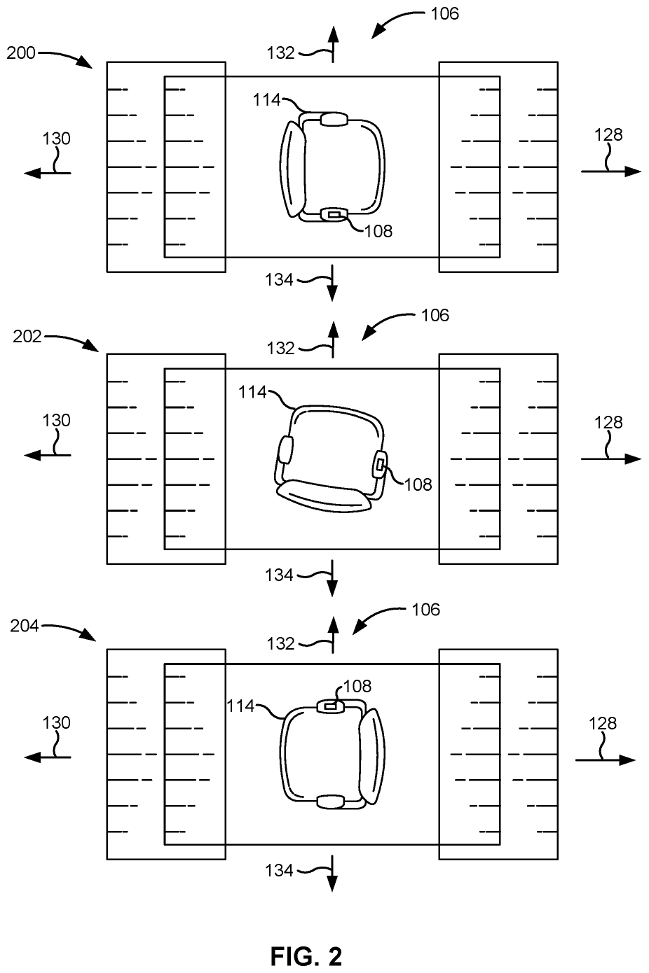

FIG. 2 is a top view of examples of an operator station 106 of the machine 100 described herein. The operator station 106 includes the operator seat 114. The operator seat 114 may be rotatable. FIG. 2 shows the operator seat 114 in a first position 200, a second position 202, and a third position 204. The positions (e.g., rotational positions) of the operator seat 114 shown in FIG. 2 and described herein are provided as examples. The operator seat 114 can be configured to rotate into additional positions not depicted and/or described herein.

The operator seat 114 can move (e.g., rotate) from facing the forward direction 128 (e.g., in the first position 200) to facing the reverse direction 130 (e.g., in the third position 204). For example, the operator seat 114 may rotate from facing the forward direction 128 to facing the reverse direction 130 by rotating to face a left direction 132 (e.g., left relative to the forward direction 128), such as shown in the second position 202. For example, the operator seat 114 can be positioned at any left facing angle between facing the forward direction 128 and facing the reverse direction 130. In an example, the operator seat 114 can rotate 360 degrees (e.g. at N degree increments, such as 15 degree increments). For example, the operator seat 114 may rotate from facing the forward direction 128 to facing the reverse direction 130 by rotating to face a right direction 134 (e.g., right relative to the forward direction 128). In an example, the operator seat 114 can be configured to rotate a pre-determined angle that is less than 360 degrees, such as 180 degrees. The operator seat 114 can be configured such that the maximum rotation angle can be fixed or variable.

The drive system control 108 can control movement of the machine 100 in the forward direction 128 and the reverse direction 130. In some examples, the steering of the machine 100 can be wholly separate from the drive system control 108 (e.g., the steering system control 110 can be part of controlling the steering system for the machine 100). The direction and speed of movement of the machine 100 can be dependent on a position of a lever (e.g., a joystick) of the drive system control 108. The controller 126 of the machine 100 can be connected to and in communication with the drive system control 108 and the operator seat 114 such that the controller 126 can determine a direction of movement, a speed of movement of the machine 100, and/or a rotational position of the operator seat 114, as described in more detail elsewhere herein. In an example, the control system of the machine 100 can include one or more controllers (similar to the controller 126) for the drive system control 108 and/or for the operator seat 114, and such controllers can be connected to and in communication with a main control unit (e.g., the controller 126) of the machine 100. In some examples, the operator station 106 and/or the operator seat 114 include one or more sensors. The one or more sensors can be configured to measure and/or detect a position (e.g., a rotational position) of the operator seat 114. For example, the one or more sensors may include a camera, a proximity sensor, a rotary encoder, a potentiometer, an optical encoder, a magnetic rotary sensor, a laser displacement sensor, a capacitive sensor, and/or another type of sensor configured to detect a rotational position of the operator seat 114.

As indicated above, FIG. 2 is provided as an example. Other examples may differ from what is described in connection with FIG. 2.

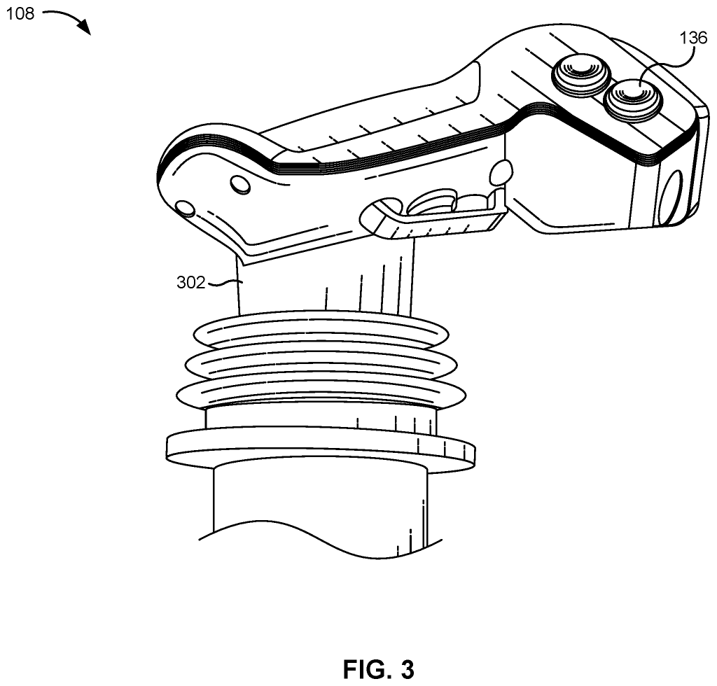

FIG. 3 is a perspective view of an example drive system control 108 of the machine 100 described herein. As shown in FIG. 3, the drive system control 108 may be, or may include, a lever 302. The lever 302 may be a joystick. The lever 302 may be pivotable about one or more axes.

The lever 302 may be configured to move along a single axis. In other examples, the lever 302 can include a dual-axis design such that the lever 302 is configured to move along multiple axes. For example, the lever 302 can move in a forward direction and a reverse direction (as defined on a longitudinal axis), as well as to the left and to the right (as defined on a lateral axis). Such movement is all relative to a neutral position of the lever 302, which can correspond to an origin on the coordinate system defined by the longitudinal and lateral axes. A speed of the machine 100 can depend, in part, on a distance of the lever 302 from neutral in at least one of the longitudinal and lateral directions. For example, if the operator moves the lever 302 all the way forward (as far away from neutral in a longitudinal direction away from the operator), the machine 100 can move in the forward direction 128 at full or maximum speed. As another example, if the operator moves the lever 302 all the way backward (as far away from neutral in a longitudinal direction toward from the operator), the machine 100 can move in the reverse direction 130 at full or maximum speed. A position of the lever 302 along a given axis (e.g., the longitudinal axis) may determine the speed of the machine 100.

The machine 100 can be designed to do numerous passes in the forward direction 128 and the reverse direction 130, during a working operation of the machine 100, in order to compact the asphalt or other road material. It can be beneficial to reduce an amount of time that the machine 100 is stopped as the machine 100 changes from the forward direction 128 to the reverse direction 130 (and vice versa). The systems and methods described herein can help to minimize the amount of time that the machine 100 is stopped as the machine 100 changes directions and to cause direction changes to occur smoothly and in a controlled manner (e.g., thereby resulting in improved mat quality by reducing the amount of time that the machine 100 is stopped while on hot paving material). Additionally, it can be beneficial for the operator to adjust the operator seat 114 as quickly as possible when the machine 100 changes direction. Such change in seat position can be disorienting for the operator. The systems and methods described herein can help minimize such disorientation by making the direction change of the machine 100 more intuitive to the desired direction of movement of the machine 100.

In some examples, the machine 100 may include a shuttle shift input component 136. For example, the machine 100 may include a shuttle shift (sometimes referred to as a shuttle shift transmission or a power shuttle). The shuttle shift is a component that enables seamless shifting between forward and reverse gears of the machine 100, enhancing maneuverability and efficiency of the machine 100. The shuttle shift facilitates quick and convenient directional changes of the machine 100 by allowing the operator to shift between forward and reverse gears without the need for clutching or stopping the machine 100. The shuttle shift input component 136 enables the operator to provide an operator input to engage the forward or reverse gears of the machine 100. The shuttle shift may include an input shaft connected to the power source 118 to transfer torque to a shuttle assembly. The shuttle assembly includes one or more shuttle gears and clutch components. The shuttle assembly is configured to engage and disengage the forward and reverse gears (e.g., without stopping the machine 100 and/or placing the power source 118 into neutral). The shuttle shift may include an output shaft configured to transmit power to the drivetrain of the machine 100 based on a selected gear, driving the machine 100 in the forward direction 128 or in the reverse direction 130. The shuttle shift allows the operator to shift between forward and reverse gears of the machine 100 with minimal effort and interruption to operation of the machine 100.

For example, the operator may provide an input to the shuttle shift input component 136. The input may cause the shuttle shift to change a direction of movement of the machine 100. For example, if the machine 100 is moving in the forward direction 128, the shuttle shift may cause the machine 100 to switch to moving in the reverse direction 130 in response to the input to the shuttle shift input component 136. Alternatively, if the machine 100 is moving in the reverse direction 130, the shuttle shift may cause the machine 100 to switch to moving in the forward direction 128 in response to the input to the shuttle shift input component 136. To complete the change in direction of the machine 100, the operator may provide a continuous input to the shuttle shift input component 136 (e.g., hold a button where the shuttle shift input component 136 is a button) until the machine 100 completes the change in direction of movement. In other examples, a single input to the shuttle shift input component 136 (e.g., a single press of the button) may cause the machine 100 to initiate and complete the change in direction of movement. The operator can quickly switch between forward and reverse gears without the need to manually stop the machine 100 or engage a clutch, enhancing maneuverability, especially in confined spaces or during repetitive tasks of the machine 100. By eliminating the need for clutching the machine 100, the shuttle shift reduces operator fatigue and enhances safety by providing seamless control over movements of the machine 100. The shuttle shift enables smooth and controlled direction changes of the machine 100 (e.g., reducing a risk of inconsistent and/or sudden movements that may be caused by an operator input when changing the direction of movement), thereby enabling the direction changes without the operator having to take additional actions and/or to occur more smoothly than if the operator manually performed the direction changes (e.g., using a lever, such as a joystick).

In some examples, the shuttle shift input component 136 may be a component (e.g., one or more buttons or one or more switches) on the drive system control 108 and/or the lever 302 (e.g., as shown in FIG. 3). For example, the shuttle shift input component 136 may include a single component (e.g., a single button or a single switch). An operator input to the component may cause the shuttle shift to change the direction of movement of the machine 100 (e.g., from the forward direction 128 to the reverse direction 130 or from the reverse direction 130 to the forward direction 128). As another example, the shuttle shift input component 136 may include a first component (e.g., a first button or a first switch) corresponding to the forward direction 128 and a second component (e.g., a second button or a second switch) corresponding to the reverse direction 130 (e.g., as shown in FIG. 3). An operator input to the first component may cause the machine 100 to travel in the forward direction 128, and an operator input to the second component may cause the machine 100 to travel in the reverse direction 130.

As another example, the shuttle shift input component 136 may include a trigger, a lever (e.g., a control lever), and/or an input on the display 112 (e.g., a touch screen input), among other examples. In some examples, the shuttle shift input component 136 may include the lever 302. For example, a given movement of the lever 302 may trigger the shuttle shift to change the direction of travel of the machine 100. For example, the lever 302 may be movable or pivotable along a first axis to cause the machine 100 to move in the forward direction 128 or the reverse direction 130 (e.g., where a speed of the machine 100 is based on a position of the lever along the first axis). An input to the shuttle shift input component 136 may include a movement of the lever 302 along a second axis. For example, the speed of the machine 100 may be controlled by moving the lever 302 along the first axis (e.g., pushing the lever 302 away from the operator seat 114 to increase the speed or pulling the lever 302 toward the operator seat 114 to reduce the speed). The input to the shuttle shift input component 136 may include a movement of the lever 302 in the second axis (e.g., a movement of the lever 302 to the left or right relative to the operator seat 114).

As indicated above, FIG. 3 is provided as an example. Other examples may differ from what is described in connection with FIG. 3.

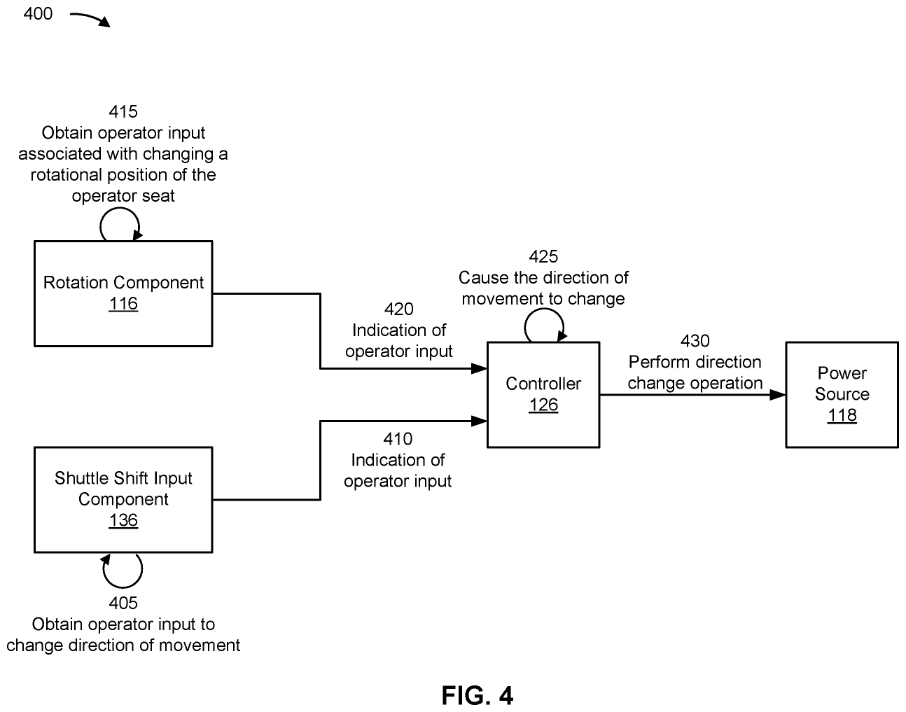

FIG. 4 is an example 400 associated with shuttle shift based direction changes for a work machine (e.g., the machine 100) described herein. The controller 126 may perform the actions or operations described herein in connection with the example 400 (or may cause the actions or operations to be performed).

As shown by reference number 405, the shuttle shift input component 136 may obtain an operator input. The operator input may indicate a change in the direction of movement of the machine 100. For example, the machine 100 may be moving in a first direction (e.g., in the forward direction 128 or the reverse direction 130). The operator input (e.g., to the shuttle shift input component 136) may indicate that the operator wishes to change the direction of movement to a second direction (e.g., changing from the forward direction 128 to the reverse direction 130 or changing from the reverse direction 130 to the forward direction 128). The operator input may include the operator pushing a button, flipping a switch, engaging (e.g., moving) a shuttle shift lever, and/or moving the lever 302, among other examples.

As shown by reference number 410, the controller 126 may obtain, receive, and/or detect an indication of the shuttle shift operator input. For example, the controller 126 may communicate with the shuttle shift input component 136 and/or the drive system control 108 to obtain, receive, and/or detect the indication of the shuttle shift operator input. For example, the controller 126 may obtain, receive, and/or detect an indication of an operator input to the shuttle shift input component 136. The operator input may indicate that the shuttle shift of the machine 100 is to cause the machine 100 to change from moving in a first direction to moving in a second direction.

As shown by reference number 415, the rotation component 116 may obtain an operator input associated with changing a rotational position of the operator seat 114. For example, an operator input may indicate that the operator seat is changing from a first position to a second position, such as from the first position 200 to the third position 204. The operator input associated with changing a rotational position of the operator seat 114 may be associated with an interaction with the rotation component 116. For example, the operator may engage or disengage the rotation component 116.

The operator input may be associated with unlocking a rotational position of the operator seat 114 and/or locking a rotational position of the operator seat 114. For example, the operator input may include a first input associated with unlocking a rotational position of the operator seat 114 while the operator seat is in a first position and a second input associated with locking the rotational position of the operator seat 114 while the operator seat is in a second (e.g., different) position. In some implementations, the operator input is associated with changing a position of the operator seat 114 of the machine 100. The operator input is associated with changing the position of the operator seat 114 from a first position to a second position. In some implementations, the first position is associated with the operator seat 114 facing a first direction (e.g., a direction of movement of the machine 100 when the operator input to the shuttle shift input component 136 is obtained) and the second position is associated with the operator seat facing the second direction (e.g., the direction indicated by the operator input to the shuttle shift input component 136). For example, the operator input indicates that the position of the operator seat 114 is rotating to face toward the second direction and away from the first direction. In some implementations, the operator input is associated with initiating a change in the position of the operator seat 114. Additionally, or alternatively, the operator input is associated with completing the change in the position of the operator seat 114.

As shown by reference number 420, the controller 126 may obtain an indication of the operator input associated with the operator seat 114. For example, the controller 126 may obtain, receive, and/or detect an indication that the rotational position of the operator seat 114 is changing and/or has changed. The controller 126 may obtain, receive, and/or detect the indication of the operator input associated with the operator seat 114 by communicating with the rotation component 116. Additionally, or alternatively, the controller 126 may obtain, receive, and/or detect the operator input associated with the operator seat 114 via measurements or detections obtained via one or more sensors (e.g., that are positioned on the operator seat 114 and/or in the operator station 106). For example, the one or more sensors may provide data (e.g., sensor data) that indicates that the operator seat 116 has begun rotating and/or has completed a rotation. The sensor data may indicate a position (e.g., a rotational position) of the operator seat 114.

As shown by reference number 425, the controller 126 may cause the direction of movement of the machine 100 to change. For example, the controller 126 may cause the direction of movement to change based on, in response to, the operator input to the shuttle shift input component 136. The controller 126 may cause the shuttle shift and/or the power source 118 to cause the machine 100 to switch from moving in the first direction to moving in the second direction. The first direction may approximately 180 degrees from the second direction (e.g., the first direction and the second direction may be within 180 degrees (plus or minus a tolerance) from each other). In some implementations, the controller 126 may cause the direction of movement to change based on, or in response to, obtaining, receiving, or detecting the operator input to the shuttle shift input component 136 regardless of a position or rotation of the operator seat 114.

In other examples, the controller 126 may cause the direction of movement to change based on, or in response to, obtaining, receiving, or detecting both a first operator input (e.g., the operator input to the shuttle shift input component 136) and a second operator input (e.g., indicating an interaction or rotation of the operator seat 114). Switching the direction of movement in response to obtaining, receiving, or detecting both operator inputs may improve a likelihood that the controller 126 is correctly switching the direction of movement and reduce confusion for the operator by ensuring the operator seat 114 is facing toward the direction of movement.

For example, the change in a direction of movement of the machine 100 is responsive to the first input to the shuttle shift input component 136 and the second input indicating that a rotational position of the operator seat 114 is changing. The controller 126 may cause the direction of movement to change based on, or in response to, the second input indicating that the position of the operator seat 114 is rotating to face toward the second direction and away from the first direction. In other words, the controller 126 may initiate or cause the change in the direction of movement based on, or in response to, the operator seat 114 rotating to face the new direction of movement (e.g., where the new direction of movement is indicated by the operator input to the shuttle shift input component 136) and based on, or in response to, obtaining an indication of the operator input to the shuttle shift input component 136.

The controller 126 may cause the change in the direction of movement based on, or in response to, obtaining the first input to the shuttle shift input component 136 and the second input indicating that a rotational position of the operator seat 114 is changing regardless of an order in which the first input and the second input are obtained by the controller 126. In some implementations, the controller 126 may cause the change in the direction of movement based on, or in response to, obtaining the first input to the shuttle shift input component 136 followed by obtaining the second input indicating a change in a rotational position of the operator seat 114. The controller may cause the change in the direction of movement based on, or in response to, obtaining the first input and the second input within a given amount of time. For example, if a difference between a first time (e.g., at which the controller 126 obtains the first input) and a second time (e.g., at which the controller 126 obtains the second input) satisfies a threshold, then the controller 126 may cause the change in the direction of movement.

The controller 126 may cause the change in the direction of movement based on, or in response to, the second input indicating that the rotational position of the operator seat 114 has changed from a first rotational position to a second rotational position. In some implementations, the first rotational position may be associated with the operator seat 114 facing a first direction and the second rotational position may be associated with the operator seat 114 facing a second direction. For example, the operator seat may be configured to enable the operator to select a first one or more rotational positions associated with a first direction (e.g., the forward direction 128 as shown in FIG. 2) and a second one or more rotational positions associated with a second direction (e.g., the reverse direction 130 as shown in FIG. 2). For example, the operator seat 114 may include a set of rotational positions at N degree increments (e.g., 15 degree increments). Assuming a plane along the direction of travel of the machine 100 (e.g., a plane where 0 degrees is toward the forward direction 128 and 180 degrees is toward the reverse direction 130 as shown in FIG. 2), the first one or more rotational positions associated with the first direction may include any rotational positions associated with positions from 0 degrees to 90 degrees and/or from 270 degrees to 360 degrees. The second one or more rotational positions associated with the second direction may include any rotational positions associated with positions from 90 degrees to 270 degrees (e.g., a rotational position of 90 degrees and/or 270 degrees may not be selectable by the operator to avoid ambiguity as to the direction that the operator seat 114 is facing). The controller 126 may be configured to determine that the second input indicates that the rotational position of the operator seat 114 has changed from causing the operator seat 114 to face the first direction to causing the operator seat 114 to face the second direction. The controller 126 may cause the change in the direction of movement based on, or in response to, the second input indicating that the rotational position of the operator seat 114 has changed from causing the operator seat 114 to face the first direction to causing the operator seat 114 to face the second direction. For example, the controller 126 may determine that the first rotational position is included in the first one or more rotational positions associated with the first direction and that the second rotational position is included in the second one or more rotational positions associated with the second direction.

In some implementations, the first rotational position may greater than or equal to 90 degrees from the second rotational position. In other implementations, the first rotational position may greater than or equal to 30 degrees, 45 degrees, or another quantity of degrees from the second rotational position. In some implementations, the first rotational position is approximately 180 degrees from the second rotational position (e.g., the first rotational position and the second rotational position are within 180 degrees (plus or minus a tolerance) from each other). For example, the controller 126 may cause the change in the direction of movement based on, or in response to, the operator seat 114 rotating at least halfway (e.g., 90 degrees) from facing the first direction to facing the second direction. In other examples, the controller 126 may cause the change in the direction of movement based on, or in response to, the operator seat 114 rotating substantially all the way (e.g., 180 degrees) from facing the first direction to facing the second direction. This helps insure the operator is facing (or at least beginning to face) in the new direction of travel before the direction of movement begins to change.

The change in the direction of movement may be responsive to the second input indicating that an operator has interacted with the rotation component 116 of the operator seat 114 to initiate the change in the rotational position of the operator seat 114 (e.g., to unlock the operator seat 114 to allow the operator seat 114 to rotate). In some implementations, the change in the direction of movement may be responsive to the second input indicating that an operator has interacted with the rotation component 116 of the operator seat 114 to complete the change in the rotational position of the operator seat 114 (e.g., to lock the operator seat 114 in a new rotational position).

As shown by reference number 430, the controller 126 may perform a direction change operation. For example, the controller 126 may interact with the shuttle shift and/or the power source 118 to cause the machine 100 to change the direction of movement from the first direction to the second direction. For example, the controller 126 may cause the shuttle shift and/or the power source 118 to switch or change gears of the power source to cause the direction of movement to change. The controller 126 may cause the direction of movement to change without causing the power source 118 to be placed in neutral.

In some implementations, the controller 126 may reduce a speed of the machine 100 from an operating speed to a directional change state responsive to the first input and the second input. The directional change state may be associated with a reduced speed as compared to the operating speed. The operating speed may be indicated by a position of the lever 302. The controller 126 may cause, via the power source 118 (e.g., via the shuttle shift and/or a transmission of the power source 118), the change in the direction of movement of the machine 100. The controller 126 may increase, after changing the direction of movement, the speed of the work machine to the operating speed (e.g., may return the speed of the machine 100 to the operating speed in the second direction). For example, the controller 126 may cause the speed of the machine 100 to be ramped down and ramped up in response to obtaining the first input and the second input, as described elsewhere herein.

The controller 126 may be configured to cause the machine 100 to briefly stop when changing the direction of movement from the first direction to the second direction. For example, the controller 126 may be configured to cause the machine 100 to slow down, briefly stop, and change the direction of movement in a controlled and smooth manner. This avoids applying an undesirable level of pressure to paving material during direction of movement changes of the machine 100.

The controller 126 may increase the speed of the machine 100 based on obtaining an indication that the position of the operator seat 114 has changed and that the operator seat 114 is in a locked position. For example, the controller 126 may refrain from increasing the speed of the work machine while the operator seat 114 is in the process of being rotated to the new position. This increases the safety of the operator by ensuring that the speed of the machine 100 is not increased while the operator seat 114 is in an unlocked position.

In some implementations, causing the direction of movement of the work machine to change may include stopping or disabling one or more systems and/or one or more components of the machine 100. For example, the machine 100 (e.g., the controller 126) may obtain the input to the shuttle shift component 136. In response to obtaining the input to the shuttle shift component 136, the machine 100 (e.g., the controller 126) may cause one or more systems and/or one or more components of the machine 100 to stop operation and/or be disabled. As an example, the one or more systems and/or one or more components may include a vibratory component of the machine 100 (e.g., that causes the compaction drums 102, 104 or another component of the machine 100 to vibrate for a vibratory compaction operation). The machine 100 may (e.g., in response to obtaining the input to the shuttle shift component 136) cause the one or more systems and/or the one or more components to stop operation and/or be disabled and may cause the machine 100 to reduce a speed of the machine 100 from an operating speed to a directional change state. In response to obtaining the second input (e.g., indicating that an operator has interacted with the rotation component 116 and/or completed an operator seat 114 position change to face a new direction), the machine 100 (e.g., the controller 126) may cause the machine 100 to briefly stop and change the direction of movement in a controlled and smooth manner (e.g., to begin moving in the new direction indicated by the operator seat 114 position change).

The machine 100 (e.g., the controller 126) may cause a speed of the machine 100 to be limited in the new direction (e.g., may cause the machine 100 to travel at a speed that is less than or equal to a directional change speed) until the controller 126 detects that an input is no longer being provided to the shuttle shift input component 136 (e.g., until the operator releases the shuttle shift input component 136). This ensures that the machine 100 does not return to the operational speed until the operator is prepared and ready to resume operation. Additionally, the machine 100 (e.g., the controller 126) may cause the one or more systems and/or the one or more components to remain disabled or non-operational until the controller 126 detects that an input is no longer being provided to the shuttle shift input component 136 (e.g., until the operator releases the shuttle shift input component 136).

If the machine 100 (e.g., the controller 126) detects that the input is no longer being provided to the shuttle shift input component 136 (e.g., after causing the machine 100 to slow down), but detects that no operator seat 114 position change has occurred prior to the release of the shuttle shift input component 136, then the machine 100 (e.g., the controller 126) may cause the machine 100 to return to the operational speed in the original direction of movement. In such examples, the machine 100 (e.g., the controller 126) may cause the one or more systems and/or the one or more components to remain disabled or non-operational until the controller 126 detects an operator input to resume operation of the one or more systems and/or the one or more components.

As indicated above, FIG. 4 is provided as an example. Other examples may differ from what is described in connection with FIG. 4.

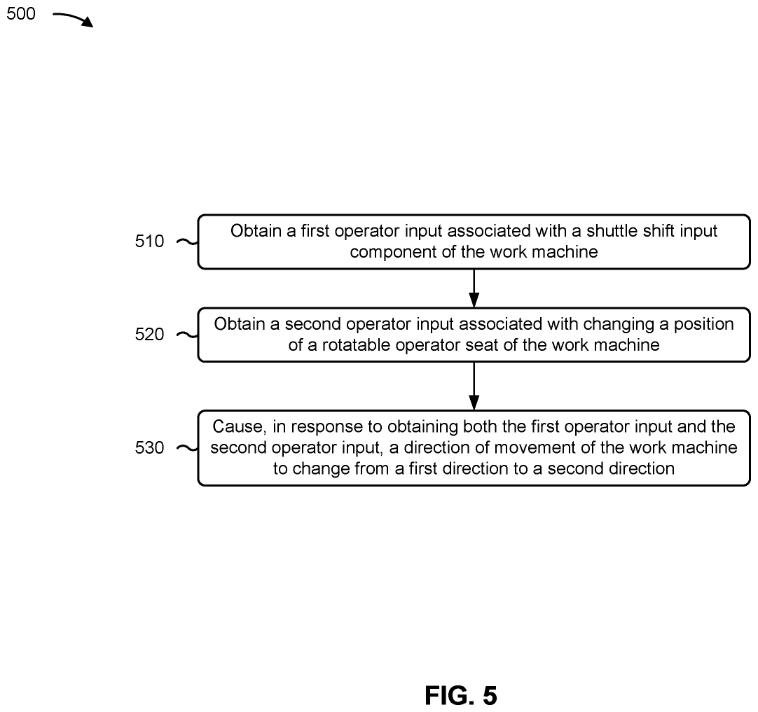

FIG. 5 is a flowchart of an example process 500 associated with shuttle shift based direction changes for a work machine (e.g., the machine 100). One or more process blocks of FIG. 5 may be performed by a controller (e.g., the controller 126). Additionally, or alternatively, one or more process blocks of FIG. 5 may be performed by another device or a group of devices separate from or including the controller, such as another device or component that is internal or external to the machine 100.

As shown in FIG. 5, process 500 may include obtaining a first operator input associated with a shuttle shift input component of the work machine (block 510). For example, the controller may obtain a first operator input associated with a shuttle shift input component of the work machine, as described above. The work machine may be a compactor machine.

As further shown in FIG. 5, process 500 may include obtaining a second operator input associated with changing a position of a rotatable operator seat of the work machine (block 520). For example, the controller may obtain a second operator input associated with changing a position of a rotatable operator seat of the work machine, as described above. The second operator input may be associated with initiating a change in the position of the rotatable operator seat.

As further shown in FIG. 5, process 500 may include causing, in response to obtaining both the first operator input and the second operator input, a direction of movement of the work machine to change from a first direction to a second direction (block 530). For example, the controller may cause, in response to obtaining both the first operator input and the second operator input, a direction of movement of the work machine to change from a first direction to a second direction, as described above. The first direction is approximately 180 degrees from the second direction. The second operator input may be associated with changing the position of the rotatable operator seat from a first position to a second position. The first position is associated with the rotatable operator seat facing the first direction and the second position is associated with the rotatable operator seat facing the second direction.

Causing the direction of movement of the work machine to change may be in response to the second operator input indicating that the position of the rotatable operator seat is rotating to face toward the second direction and away from the first direction.

Causing the direction of movement of the work machine to change may include reducing a speed of the work machine from an operating speed in the first direction to stationary, causing, via a transmission of the work machine, the direction of movement of the work machine to change from the first direction to the second direction, and increasing the speed of the work machine from stationary to the operating speed in the second direction. Reducing the speed of the work machine may be based on obtaining the first operator input and the second operator input indicating an initiation of a change in the position of the rotatable operator seat. Increasing the speed of the work machine may be based on obtaining an indication that the position of the rotatable operator seat has changed and that the rotatable operator seat is in a locked position.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

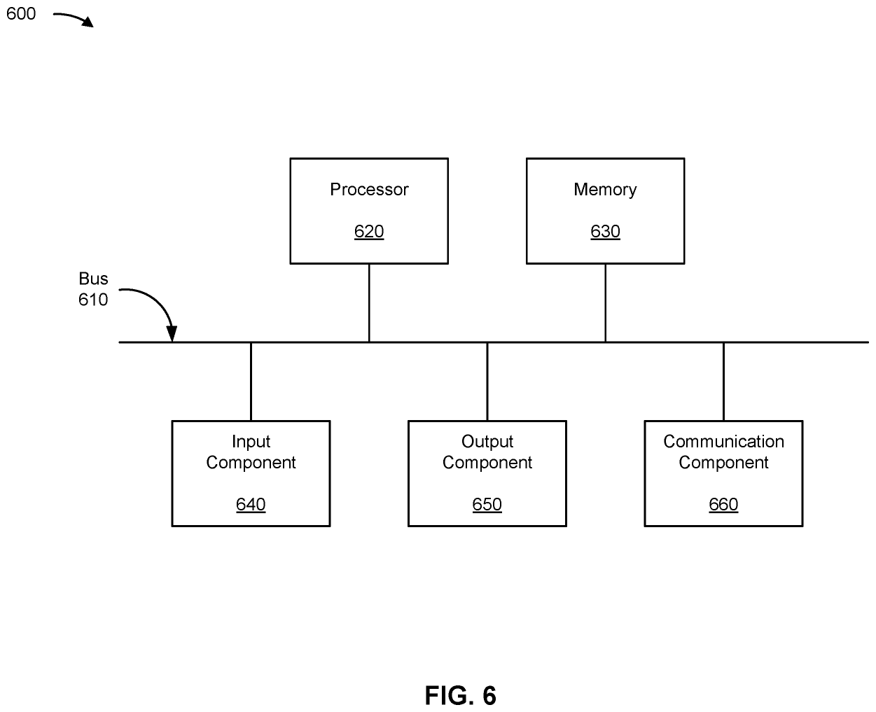

FIG. 6 is a diagram of example components of a device 600 associated with shuttle shift based direction changes for a work machine (e.g., the machine 100). The device 600 may correspond to the machine 100, the controller 126, the rotation component 116, the shuttle shift input component 136, and/or another component internal or external to the machine 100. In some implementations, the controller 126, the rotation component 116, the shuttle shift input component 136, and/or another component internal or external to the machine 100 may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. In some implementations, the memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry may be used instead of or in combination with the instructions to perform one or more operations or processes described herein. Additionally, or alternatively, the processor 620 (e.g., one or more processors 620 individually or collectively) may be configured to perform one or more operations or processes described herein. Where reference is made to one or more elements (e.g., one or more processors) performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

### INDUSTRIAL APPLICABILITY

Changing the direction of movement of a compactor machine may result in the compactor machine slowing down and/or stopping while on hot paving material (e.g., to place the engine of the compactor machine into neutral to change the direction of movement). As a result of the compactor machine slowing down and/or stopping while on hot paving material, a surface of the paving material may be deformed or damaged, thereby requiring reworking or repair of the surface that consumes machine hours, increases machine wear, and/or increases fuel consumption. Further, an operator may use a lever (e.g., a joystick) to control the direction of movement of the compactor machine. The frequent changes between the forward and reverse directions may cause operator fatigue associated with interacting with the lever. In some cases, the compactor machine may have an operator seat that is configured to rotate so that the operator can adjust their position, depending on the direction the compactor machine is moving. The frequent changes between the forward and reverse directions in combination with the rotatable operator seat may be disorienting for the operator, thereby introducing safety risks caused by the operator being incorrect as to the direction of movement that will result from an input to the lever by the operator.

Some implementations described herein enable shuttle shift based direction changes for a work machine, such as a compactor machine. For example, a change of direction of the work machine may be based on, or in response to, an operator input to a shuttle shift input component. As a result, the operator can quickly switch between forward and reverse gears without the need to stop the work machine or engage a clutch, enhancing maneuverability, especially in confined spaces or during repetitive tasks of the work machine. By eliminating the need for clutching and stopping the work machine, the shuttle shift reduces operator fatigue and enhances safety by providing seamless control over movements of the work machine.

The work machine (e.g., a controller of the work machine) may be configured to cause the change in direction to occur smoothly and in a controlled manner. For example, the controller may cause the work machine to briefly stop when changing the direction of movement from a first direction to a second direction. For example, the controller may be configured to cause the work machine to slow down, briefly stop, and change the direction of movement in a controlled and smooth manner. This avoids applying an undesirable level of pressure to paving material during direction of movement changes of the machine (e.g., the change of direction may occur smoothly and with minimized amount of time where the work machine is stopped on hot paving material).

In some implementations, the change of direction of the work machine may be based on, or in response to, a first operator input to a shuttle shift input component and a second operator input indicating that a rotational position of an operator seat is changing. For example, a controller of the work machine may cause the change in direction based on, or in response to, obtaining both the first operator input and the second operator input. This ensures that the change in direction of movement occurs only when the operator actually intends to change the direction by relying on multiple inputs to cause the change in the direction of movement. Additionally, this improves a likelihood that the operator is facing toward the direction of movement, thereby mitigating the disorientation for the operator, such as when the work machine is frequently changing the direction of movement.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A work machine, comprising:
a power source configured to move the work machine in a forward direction and a reverse direction;
an operator seat rotatably attached to the work machine;
a lever that is movable along a first axis to cause the work machine to move in the forward direction or the reverse direction; and
a shuttle shift input component,
wherein a change in a direction of movement of the work machine, of the forward direction and the reverse direction, is responsive to a first input to the shuttle shift input component and a second input indicating that a rotational position of the operator seat is changing.

2. The work machine of claim 1, wherein a speed of the work machine is based on a position of the lever.

3. The work machine of claim 1, wherein the work machine is configured to:
reduce a speed of the work machine from an operating speed to a directional change state responsive to the first input and the second input,
cause, via the power source, the change in the direction of movement, and
increase, after changing the direction of movement, the speed of the work machine to the operating speed.

4. The work machine of claim 1, wherein the change in the direction of movement is responsive to the second input indicating that the rotational position of the operator seat has changed from a first rotational position to a second rotational position.

5. The work machine of claim 4, wherein the first rotational position is associated with the operator seat facing a first direction and the second rotational position is associated with the operator seat facing a second direction.

6. The work machine of claim 4, wherein the first rotational position is approximately 180 degrees from the second rotational position.

7. The work machine of claim 1, wherein the change in the direction of movement is responsive to the second input indicating that an operator has interacted with a component of the operator seat to initiate a change in the rotational position of the operator seat.

8. The work machine of claim 1, wherein the shuttle shift input component comprises at least one of:
a button,
a trigger, or
the lever, wherein the first input is associated with a movement of the lever along a second axis.

9. A method, comprising:
obtaining, by a controller of a work machine, a first operator input associated with a shuttle shift input component of the work machine;
obtaining, by the controller, a second operator input associated with changing a position of a rotatable operator seat of the work machine; and
causing, by the controller and in response to obtaining both the first operator input and the second operator input, a direction of movement of the work machine to change from a first direction to a second direction.

10. The method of claim 9, wherein the first direction is approximately 180 degrees from the second direction.

11. The method of claim 9, wherein causing the direction of movement of the work machine to change is in response to the second operator input indicating that the position of the rotatable operator seat is rotating to face toward the second direction and away from the first direction.

12. The method of claim 9, wherein the second operator input is associated with initiating a change in the position of the rotatable operator seat.

13. The method of claim 9, wherein causing the direction of movement of the work machine to change comprises:
reducing a speed of the work machine from an operating speed in the first direction to stationary;
causing, via a transmission of the work machine, the direction of movement of the work machine to change from the first direction to the second direction; and
increasing the speed of the work machine from stationary to the operating speed in the second direction.

14. The method of claim 13, wherein reducing the speed of the work machine is based on obtaining the first operator input and the second operator input indicating an initiation of a change in the position of the rotatable operator seat, and
wherein increasing the speed of the work machine is based on obtaining an indication that the position of the rotatable operator seat has changed and that the rotatable operator seat is in a locked position.

15. The method of claim 9, wherein the second operator input is associated with changing the position of the rotatable operator seat from a first position to a second position, and
wherein the first position is associated with the rotatable operator seat facing the first direction and the second position is associated with the rotatable operator seat facing the second direction.

16. The method of claim 9, wherein the work machine is a compactor machine.

17. A controller of a work machine, comprising:
one or more memories; and
one or more processors, coupled to the one or more memories, configured to:
obtain a first operator input associated with a shuttle shift input component of the work machine;
obtain a second operator input associated with initiating a rotation of a rotatable operator seat of the work machine; and
cause, based on the first operator input and the second operator input, a direction of movement of the work machine to change from a first direction to a second direction.

18. The controller of claim 17, wherein the one or more processors, to cause the direction of movement of the work machine to change, are configured to:
cause, based on obtaining both the first operator input and the second operator input, the work machine to reduce a speed of the work machine in the first direction from an operating speed; and
cause, after reducing the speed of the work machine in the first direction, the work machine to increase the speed of the work machine to the operating speed while traveling in the second direction.

19. The controller of claim 17, wherein the second operator input is associated with the rotatable operator seat of the work machine changing from a first position to a second position.

20. The controller of claim 19, wherein the first position is greater than 90 degrees from the second position.
